(19) United States
(12) Patent Application Publication
(10) Pub. No.: US 2026/0048416 A1
(43) Pub. Date: Feb. 19, 2026

(54) BAND STRUCTURE HAVING A PIEZO-BASED MODULE FOR PROVIDING HAPTIC SENSATIONS AND SENSING ONE OR BOTH OF STATIC AND DYNAMIC PRESSURE MEASUREMENTS

(71) Applicant: Meta Platforms Technologies, LLC, Menlo Park, CA (US)

(72) Inventors: Tianshu Liu, Redmond, WA (US); Tyler Henry Christensen, Monroe, WA (US); Kevin Tyler Rhodes, Kirkland, WA (US); Erik Samuel Roby, Seattle, WA (US); Daniele Piazza, Redmond, WA (US); Laura Yu Matloff, San Mateo, CA (US); Andrew Akerson, Los Angeles, CA (US)

(21) Appl. No.: 19/300,588

(22) Filed: Aug. 14, 2025

Related U.S. Application Data
(60) Provisional application No. 63/683,936, filed on Aug. 16, 2024.
(60) Provisional application No. 63/689,581, filed on Aug. 30, 2024.

(51) Int. Cl. B06B 1/06; G06F 3/01

(52) U.S. Cl. CPC B06B 1/0644; G06F 3/011; G06F 3/017

(57) ABSTRACT

A wearable device configured to provide haptic feedback to a user using integrated actuators is described. The wearable device includes a band structure configured to be worn on a portion of a user's body and a transducer assembly coupled to the band structure. The transducer assembly includes a piezoelectric substrate configured to displace in a first direction in response to a voltage a displacement amplifier coupled to the piezoelectric substrate. The displacement amplifier includes a first plate having a first end portion coupled to the piezoelectric substrate, a second plate having a first end portion coupled to the piezoelectric substrate, and a flexible joint coupling a second end portion of the first plate and a second end portion of the second plate. The flexible joint is configured to displace in a second direction different than the first direction in response to displacement of the piezoelectric substrate in the first direction.

### RELATED APPLICATIONS

This application claims priority to U.S. Provisional Application Ser. No. 63/689,581, filed Aug. 30, 2024, entitled “Band Structure Having A Piezo-Based Module For Providing Haptic Sensations And Sensing One Or Both Of Static And Dynamic Pressure Measurements,” and U.S. Provisional Application Ser. No. 63/683,936, filed Aug. 16, 2024, entitled “Apparatus, Systems, and Methods for Wristband Haptics,” which is incorporated herein by reference.

### TECHNICAL FIELD

This relates generally to an actuator assembly configured to provide haptic feedback in conjunction with sensing static and dynamic pressure between the actuator assembly and a portion of a user's body.

### BACKGROUND

Haptic modules integrated into the capsule of a wrist-wearable device (e.g., a smart watch) may use a large amount of space within the capsule and may reduce battery lief. Currently, linear resonant actuators (LRAs) used for haptics are bulky, narrow, and are less efficient in the band of a wrist-wearable device and therefore may not be suitable for haptic feedback in a wrist-wearable device. Further, certain conventional actuators may not provide sufficient displacement for a desired range of haptic feedback. Additionally, sensors that directly measure force and/or pressure exerted by a wrist-wearable device are not used in the industry. As such, there is a need to address one or more of the above-identified challenges. A brief summary of solutions to the issues noted above are described below.

### SUMMARY

As more electronics are integrated into the bands of the wrist-wearable devices to make more space in the capsule, a thin and soft sensor that can sense pressure between a wrist-wearable device and the users skin is important as the change in pressure may change the signal process employed. Disclosed herein is a thin piezo electric actuator assembly that can provide haptics to a user from the band of a wrist-wearable device (e.g., compact wrist-band haptics) in addition to measuring static and dynamic pressure between the band of a wrist-wearable device and the wrist of a user. Thus, the piezoelectric actuator assemblies integrated into the band of a wrist-wearable device can work in conjunction with or replace haptic vibration in the capsule. Freeing up the design space within the wrist-band capsule by moving the haptic function to the band of the wrist-wearable device can save power and allow additional features to be integrated into the capsule where space is at a premium. By incorporating the haptic element from a watch puck to the wristband, the systems described herein may enable slimmer watch pucks and/or increased watch battery life (e.g., by enabling the use of a larger battery in the watch puck). Furthermore, the actuator assembly in contact with the skin can be used as a contact microphone.

Systems and methods to address one or more of the drawbacks discussed above are disclosed. A band structure configured to provide haptic sensations and perform pressure measurements is described. The band structure is configured to be worn on a portion of a user's body and includes a piezo-based module coupled to the band structure. The piezo-based module includes a component configured to couple to a user's skin. The piezo-based module is configured to (i) provide a haptic sensation to the user, and (ii) operate as a sensor to detect one or more static pressure measurements based on a fit of the band structure on the portion of the user's body or detect a dynamic pressure measurement including mechanical waves based on touch-on-world gestures performed by the user.

The present disclosure is generally directed to a piezo-lateral module that enables compact wristband haptics. By placing haptic elements in small modules, the systems described herein may enable wrist-worn devices to be configured with multiple haptic elements, enabling features such as directional haptic feedback. Although illustrated and described in terms of wristband-mounted designs, the piezo-lateral module described herein may be mounted on any type of wearable or other device, such as headbands, neckbands, gloves, other wearable devices, game controllers, phones, and/or other non-wearable devices.

One example of wrist-wearable device is described herein. This example wrist-wearable device includes one or more haptic actuators configured to provide haptic feedback to a user using integrated actuators. The wearable device includes a band structure configured to be worn on a portion of a user's body and a transducer assembly coupled to the band structure. The transducer assembly includes a piezoelectric substrate configured to displace in a first direction in response to a voltage a displacement amplifier coupled to the piezoelectric substrate. The displacement amplifier includes a first plate having a first end portion coupled to the piezoelectric substrate, a second plate having a first end portion coupled to the piezoelectric substrate, and a flexible joint coupling a second end portion of the first plate and a second end portion of the second plate. The flexible joint is configured to displace in a second direction different than the first direction in response to displacement of the piezoelectric substrate in the first direction.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an actuator assembly, in accordance with some embodiments.

FIG. 2 illustrates a wrist-wearable device with one or more integrated actuator assemblies, in some embodiments.

FIG. 3 illustrates a frequency response plot of an actuator assembly, in some embodiments.

FIG. 4 illustrates another example of an actuator assembly, in some embodiments.

FIGS. 5A-5B illustrates an example of an actuator assembly in multiple actuation states, in some embodiments.

FIG. 6 illustrates another example of an actuator assembly, in some embodiments.

FIG. 7 illustrates a displacement plot of an actuator assembly, in some embodiments.

FIGS. 8A, 8B, 8C-1, and 8C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Haptic Actuators

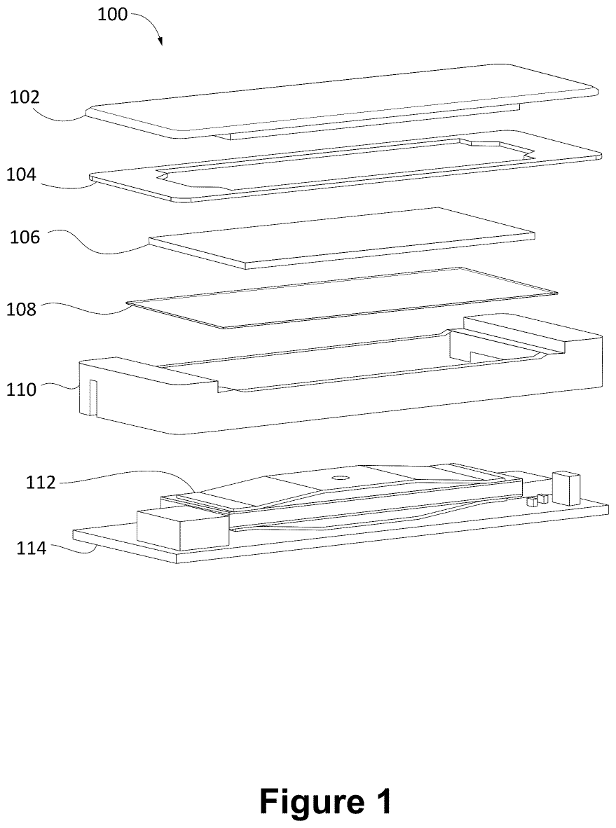

FIG. 1 illustrates an actuator assembly, in accordance with some embodiments. In some embodiments, the actuator assembly 100 is a piezo-lateral module that enables haptics inside the wrist-wearable device. For example, when the system provides haptics to a user based on a notification, the haptic response is provided to the user from the band of a wrist-wearable device in addition to and/or distinct from the capsule. In some embodiments, to provide haptic sensations to the user via the actuator assembly 100, the actuator assembly 100 must have good contact with the portion of the user's body. For example, this includes a well fitting band such that the actuator assembly 100 is in constant contact with the user's skin as opposed to a loose fitting band.

The actuator assembly 100 includes a skin coupler 102 configured to make contact with a portion of the user's body, a clip 104 made of metal and configured to resist side load, a coupler base 106 configured to resist torque, a membrane 108 configured to seal the actuator assembly 100 from water, dust, and/or dirt ingress, a mechanical enclosure 110, an actuator 112, and a driver printed circuit board (PCB) 114 configured to operate the actuator assembly 100.

In some embodiments, the driver PCB 114 includes all driver electronics to operate the actuator assembly 100 including a driver IC, inductors, and capacitors. The dimensions of the driver PCB 114 is 17.55 mm×6 mm and includes a center cut out configured to hold the actuator 112. Additionally, there is a 0.5 mm boundary around the driver PCB 114 to allow for bonding with the enclosure.

In some embodiments, the mechanical enclosure 110 is configured to add minimum resistance to the actuator motion while having resistance to side load and torque while maximizing the skin coupler area. Additionally the total height of the mechanical enclosure 110 is 2-3 mm with a wall thickness less than 0.5 mm. In some embodiments the mechanical enclosure 110 resists the actuation motion by less than 2 um.

In some embodiments, the actuator assembly 100 may have a form factor of a small rectangular box with rounded corners, a piezo-lateral module may include a mechanical clip design similar to a tactile switch that may be used to resist shear and torque applied to skin coupler. In some embodiments, a membrane design may be used to seal electronics and the actuator. In one embodiment, the enclosure wall thickness may be specified to be 0.4 mm to meet the mechanical stiffness requirements and primary insulation requirement.

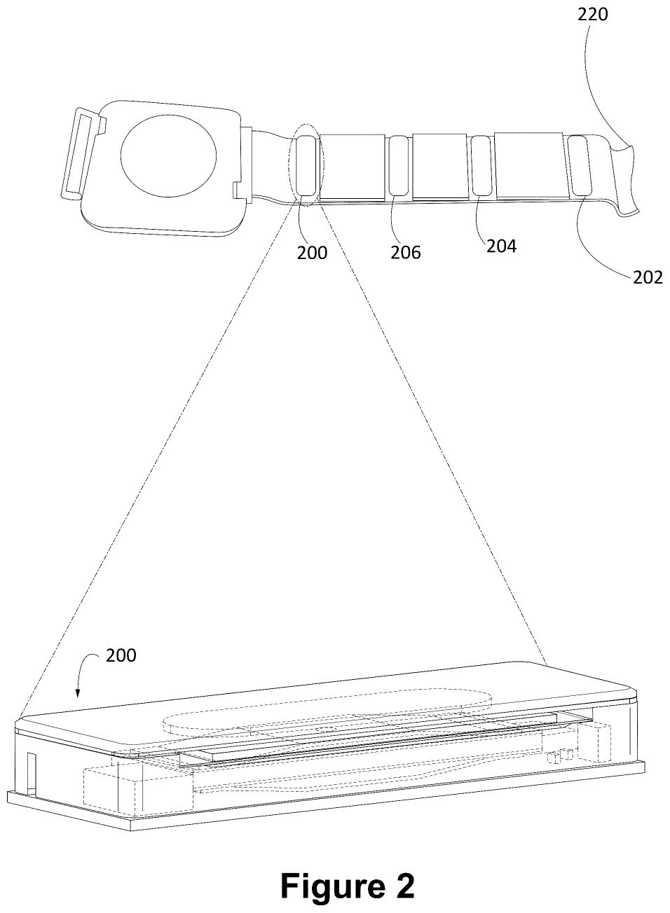

FIG. 2 illustrates a wrist-wearable device with one or more integrated actuator assemblies, in accordance with some embodiments. The wrist-wearable device 220 illustrated in FIG. 2 is coupled to one or more actuator assemblies 200-206 configured to provide a user wearing the wrist-wearable device 220 with haptic sensations. The one or more actuator assemblies 200-206 are configured to provide spatial notifications. Each respective actuator assembly 200-206 can vibrate at different frequency and/or intensity and/or at different times. For example, the wrist-wearable device 220 may be equipped with a navigational module and may signal whichever assembly is closest to facing North to vibrate continuously. In another example, the wrist-wearable device 220 may signal the actuators to rotate actuation from left to right to signal turning right, or rotate from right to left to signal turning left, in order to follow the route in a navigation application. In one example, the wrist-wearable device may be connected to a game system and may signal only actuator assembly 202 to vibrate when the wearer's character takes a small amount of damage, actuator assemblies 200 and 206 to vibrate when the wearer's character takes a moderate amount of damage, and all four modules to vibrate when the wearer's character takes significant damage. In another example, the wrist-wearable device 220 may include a communication module and may signal actuator assembly 202 to vibrate when the wearer receives a text message, actuator assembly 204 to vibrate when the wearer receives an instant message, actuator assembly 206 to vibrate when the wearer receives an email, and actuator assembly 200 to vibrate when the wearer receives a voice message.

Although four haptics modules are shown in FIG. 2, in some embodiments, the systems described herein may include more or fewer haptics modules in various arrangements. In some embodiments, the wrist-wearable device 220 is coupled to a first actuator assembly 200, which is an instance of actuator assembly 100 described in FIG. 1, a second actuator assembly 202, a third actuator assembly 204, and a fourth actuator assembly 206. In some embodiments, the systems described herein may include two, three, five, six, seven, eight, or more actuator assemblies. In some embodiments, the actuator assemblies may be evenly spaced around the wristband. In some embodiments, the actuator assemblies may be unevenly spaced. For example, pairs of actuator assemblies may be attached to the wristband immediately adjacent to one another with spaces between each pair.

In some embodiments, the actuator assembly 200 is a piezo-lateral actuator assembly such that the actuator assembly 200 can act as a pressure sensor to provide static band fit information in addition to dynamic contact pressure information. This allows the actuator assembly 200 to act as a sensor and receive multiple sensing signals such as an AC voltage signal proportional to mechanical waves propagating through the actuator which is performing as a contact microphone and a DC capacitance signal which is proportional to the static load that the actuator is subjected to. In some applications, mechanical waves or movement can actuate the actuator assembly 200 to generate an AC voltage signal proportional or otherwise representative of the mechanical wave or movement experienced by the actuator assembly 200.

The static pressure information provides valuable information about the mechanical pressure to which the actuator is subjected to. For example, the static pressure information produces measurements that determine how tightly fitting the band is on the portion of the user's body. Additionally, each point an actuator assembly is in contact with the user's skin produces an individual static contact pressure measurement such that if one of the actuator assemblies is not in full contact with the user's skin, the system may forgo sending haptic signals through the respective actuator based on that measurement. Additionally, if the band is too tight based on a static measurement above a certain measurement, the system can notify the user to loosen the band. The static measurement is calculated by measuring the change in charge (e.g., the capacitance) based on the pressure between the user's wrist and the band, which is converted into a voltage signal.

The dynamic contact pressure information is valuable for providing pressure determinations for examples such as a touch-on-world event. For example, when a user presses their finger on a table, a biomechanical wave is created based on the pressure between the user's finger and a table such that the actuator assembly 100 can determine the dynamic contact pressure between the user's finger and the table. Each touch-on-world event and/or gesture (e.g., phalanges making contact with each other) have a unique signature that can be determined by the system to perform an action or inform the system of the event.

In some examples, when there is an increase in the number of actuator assemblies, the strength of the haptic sensation felt by the user is increased 10-20% per additional coupled actuator assembly. For example, actuating multiple actuator assemblies at the same time can feel stronger than a single actuator assembly with the same frequency and amplitude. Furthermore, when the wrist is unable to detect the specific location of the haptic sensation provided, including additional actuator assemblies helps intensify the haptic sensation without changing the directionality necessarily.

In some embodiments, the system performs a skin stiffness and damping characterization to allow for system optimization when providing haptics to the user or sensing one or more pressure signals. The system optimization includes preloading the actuator which will not reduce the actuator displacement. In some embodiments, the actuator assemblies can either provide haptic sensations or sense dynamic or static pressure readings.

In wearable devices, such as haptic feedback systems, optimizing mechanical impedance can improve performance. Mechanical impedance between skin and an electrode refers to the resistance the skin-electrode interface presents to motion or vibration when mechanical energy is applied (e.g., haptic feedback from an actuator assembly). It is determined by the combined effects of the skin's elasticity, the damping characteristics of underlying tissue, and any coupling medium such as gel or adhesive. Proper impedance matching allows more efficient transfer of mechanical energy (e.g., vibrations, pressure waves) into or out of the body, reduces signal loss due to reflections, and increases measurement accuracy. It can also enhance user comfort by minimizing excessive localized pressure and ensuring stable contact during movement, leading to better reliability in both diagnostic and therapeutic applications.

Maximizing mechanical impedance between skin and an electrode involves making the interface resistant to motion for a given force. This can be achieved by increasing stiffness through rigid electrode backings and thin, firm coupling layers, enlarging contact area with adequate preload, adding mass to the electrode for higher-frequency stability, and incorporating damping materials to absorb motion. Secure, slip-free mounting and rigid fixtures also help maintain alignment and reduce micro-movement. While higher impedance can improve stability and energy transfer control, it must be balanced against comfort, blood flow, and electrical coupling requirements, with optimization tailored to the intended frequency range and application.

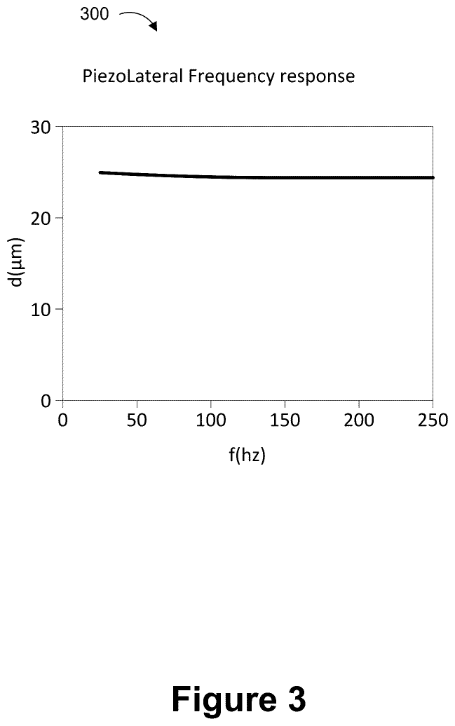

FIG. 3 illustrates a frequency response plot of an actuator assembly, in some embodiments. Chart 300 illustrates the frequency response of the piezo lateral (e.g., actuator assembly 100) between 0 and 250 Hz. As illustrated, the frequency response is flat which provides the system with an advantage of a broad band frequency signal to utilize the actuator assembly 100 as a contact microphone. This enables the actuator assembly 100 to sense both static and dynamic pressure.

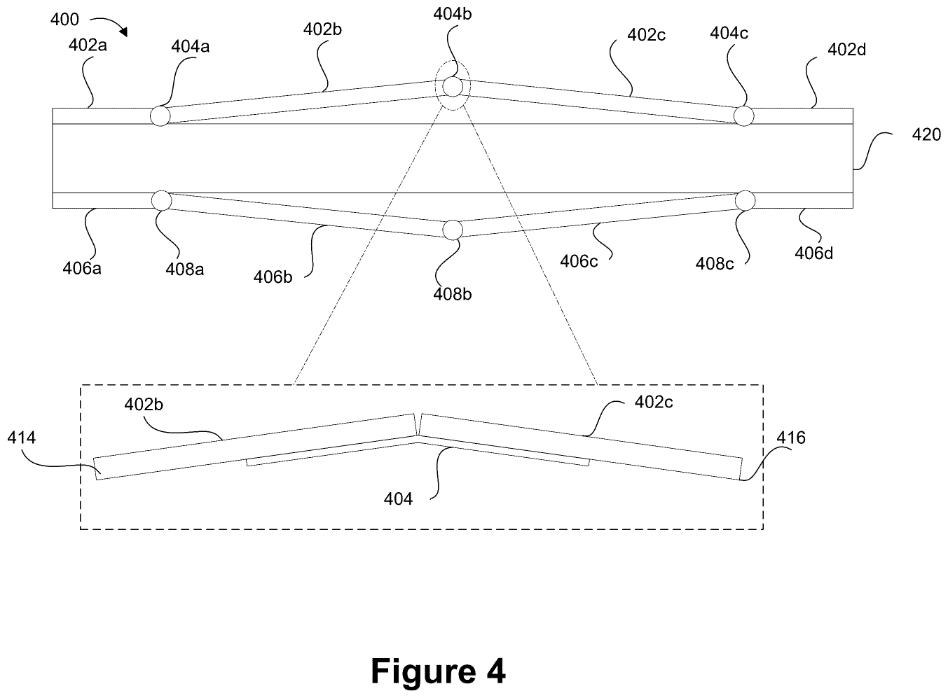

FIG. 4 illustrates another example of an actuator, in some embodiments. FIG. 4 further illustrates a haptic actuator 400 with a plate-hinge configuration. In the depicted example, the haptic actuator 400 can include elements that displace to vibrate the haptic actuator 400 to provide haptic signals or feedback to a user. The haptic actuator 400 includes at least one displacement amplifier or hinge-plate including sections 402a-402d. In some embodiments, the haptic actuator 400 includes a second displacement amplifier or hinge-plate 406 with sections 406a-406d. Hinge-plates 402 and 406 operate in the same manner but on opposite sides of the piezoelectric ceramic section 420. In some embodiments, the hinge-plates 402 and 406 are made of steel plates less than 5 mil thick. The hinge-plates 402 and 406 are coupled to a piezoelectric substrate or ceramic section 420 (e.g., a piezo material) via at least one section. For example, section 402a and 402d couple the top hinge-plate 402 to the piezoelectric ceramic section 420 and sections 406a and 406d couple the bottom hinge-plate 406 to the piezoelectric ceramic section 420. Each respective section is coupled to another respective section via a joint or connector 404 or 408 (e.g. joints or connectors 404a-d and 408a-408d). In some embodiments, some sections of each respective hinge-plate are coupled by the connector 404 or 408 and in some embodiments some of the hinge-plate sections are coupled to the sections by thinning a piece of the hinge-plate metal. In other words, the connection points of the hinge-plate sections can be distinct pieces or thinner metal sections. In some embodiments, the connector 404 or 408 is less than 2 mil thick and made out of a thin metal and/or composite tape to keep each respective section connected.

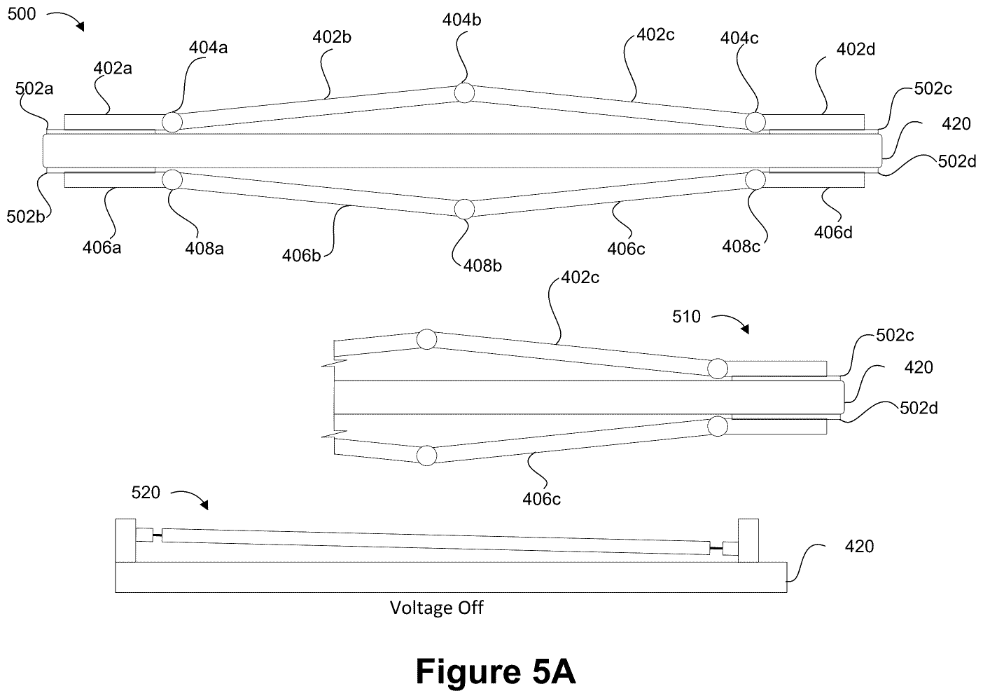

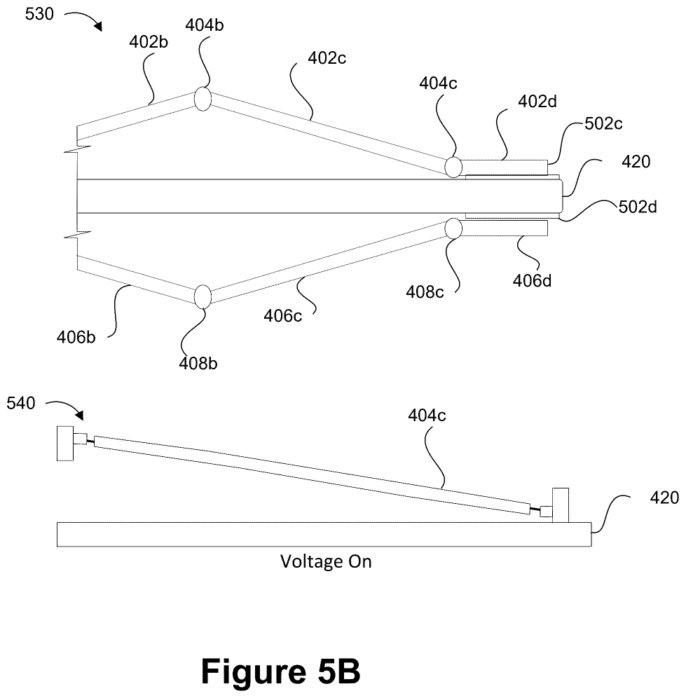

For example, FIG. 4 illustrates a detail view of connection point 404b which shows respective plate-hinge sections 402b and 402c coupled via connector 404b. The connectors 404 or 408 are configured to hold the respective sections together and act as a hinge that allows elements of the actuator to displace more than certain conventional piezo-based actuators (e.g. up to two times more displacement). During operation, upon receiving a voltage at the electrodes coupled to the piezoelectric ceramic section 420 (shown in FIGS. 5A and 5B), the ceramic section 420 contracts inward resulting in the outer portions 414 and 416 of hinge-plate sections 402b and 402c moving away or displacing upward (e.g., the actuator is actuated as shown in FIG. 5B). In other words, the outer portions 414 and 416 of hinge-plate sections 402b and 402c move closer together forming a hinged peak (as shown in FIG. 5B). As described herein, the hinge-plate sections 4026b and 406c can move away or displace downward in response to contraction of the ceramic section 420.

The displacement generated by the hinge-plate sections is the distance it travels from its rest position (shown in FIG. 5A) to its actuated position (shown in FIG. 5B). Certain conventional actuators (e.g. certain conventional piezo electric actuators) may have a displacement around 60 um when actuated at 95 V. Embodiments described herein allow for higher displacement using the same voltage compared to certain conventional actuators. For example, the displacement of the actuator 400 (e.g. the overall displacement of the hinge-plate sections as measured or observed at the central connector 404b or 408b) can be up to double the displacement (e.g., 120 um) at 95V. In some embodiments, at 60V, the displacement can be up to 130 μm of displacement while still maintaining a blocking force of over 0.5 N. In an actuator coupled to a band of a wrist-wearable device the blocking force is force applied where the motion is physically stopped such as when the actuator is producing force but there is no displacement.

FIGS. 5A-5B illustrate an example of an actuator in multiple actuation states, in some embodiments. When the actuator (e.g., actuators 500, 510, 520, 530, and 540) receive a voltage at the electrodes 502a-d, the piezoelectric ceramic section 420 changes length, causing the hinge-plate to pivot and produce a displacement. For example, as shown in FIG. 5A, the actuators 500, 510, and 520 illustrate the actuator assemblies prior to actuation and FIG. 5B illustrates the actuators 530 and 540 after they have been actuated such that the hinge-plates 402b and 402c coupled to connector 404b are moved closer together displacing the hinge-plate in an upward direction. As can be appreciated, hinge-plates 406b and 406c can similarly displace in a downward direction.

FIG. 5A further illustrates an actuator prior to a voltage being applied to the actuator 500. The hinge-plate 402 comprised of sections 402a-402d are at a state of rest or no displacement. FIG. 5A further illustrates actuators 510 and 520 which offer a detail view of the displacement of the actuators 510 and 520 prior to actuation. For example, actuator 520 shows that section 402c is close to the piezoelectric ceramic section 420 while there is no voltage applied to the electrodes coupled to the piezoelectric ceramic section 420.

FIG. 5B illustrates the actuator 530 and 540 after receiving a voltage at the electrodes (e.g., electrodes 502c and 502d) such that the hinge-plate 402 including sections 402b-402d are configured to move in response to the voltage which creates a greater displacement away from the piezoelectric ceramic section 420. Thus, the displacement of the actuator 530 is greater than the displacement of the actuators shown in FIG. 5A. During operation, the actuators can cycle between various states of displacement, and in turn haptic force or feedback, by cycling or otherwise adjusting the frequency and amplitude of voltage applied to the ceramic section 420.

FIG. 5B further illustrates a partial actuator 540 which shows section 404c and a close up of the displacement of section 404c. In some embodiments, as depicted in actuator 520 and 540, the hinge-plate arrangement can be provided by a single strut with a hinge at the top of the strut for the outer connection and a hinge at the bottom of the strut for the outer connection. Advantageously, the depicted arrangement may generate additional torque and/or actuation force compared to certain conventional actuators. In some embodiments, a single strut arrangement may reduce the weight and/or thickness of the actuator.

In some embodiments and similar to actuator assembly 200, the actuators 400, 500 can act as a pressure sensor to provide static band fit information in addition to dynamic contact pressure information. This allows the actuators 400, 500 to act as a sensor and receive multiple sensing signals such as an AC voltage signal proportional to mechanical waves propagating through the actuator which is performing as a contact microphone and a DC capacitance signal which is proportional to the static load that the actuator is subjected to. In some applications, mechanical waves or movement can actuate the actuators 400, 500 to generate an AC voltage signal proportional or otherwise representative of the mechanical wave or movement experienced by the actuators 400, 500.

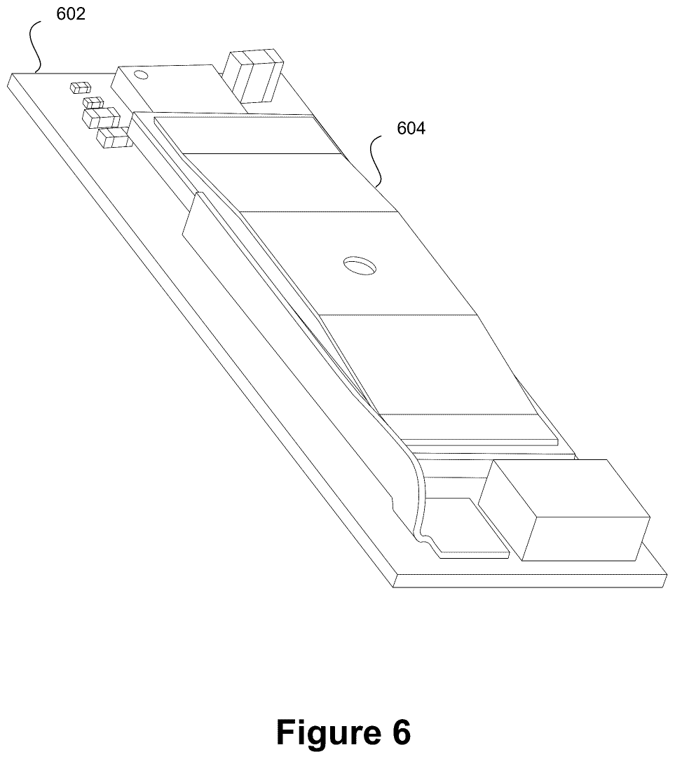

FIG. 6 illustrates another example of an actuator assembly, in some embodiments. The actuator assemblies illustrated in FIGS. 1-5B are configured to be mounted onto a printed circuit board (PCB) 602. In some embodiments, the PCB dimensions are 17.5 mm×6 mm. The PCB 602 is coupled to the electronics in the wrist-wearable device 220 such that each actuator 604 can send and receive electric signals to and from the other electronics integrated to or coupled to the wrist-wearable device 220 in addition to receiving power to operate the actuator assemblies. The actuator 604 is any one of the actuator examples illustrated in FIGS. 1-5B.

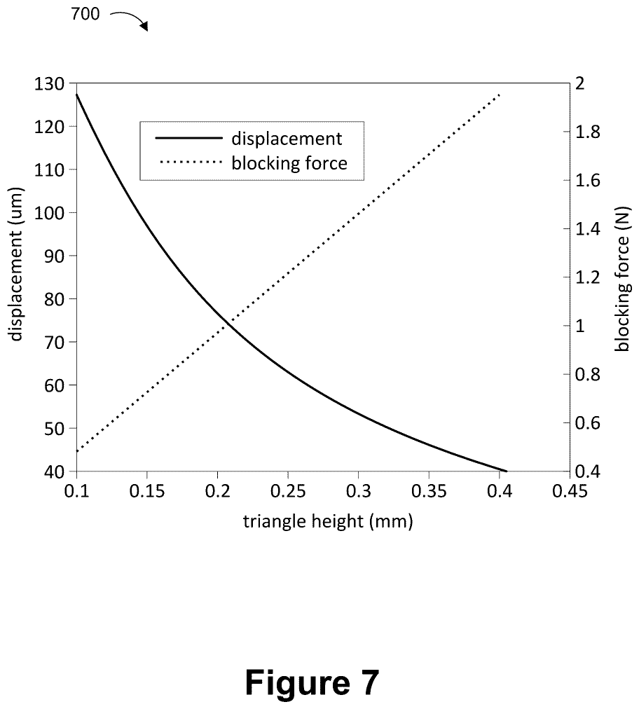

FIG. 7 illustrates a displacement plot of an actuator assembly, in some embodiments. Graph 700 illustrates a graph plotting haptic actuator displacement against blocking force which illustrates the relationship between the maximum displacement of the actuator and the generated resisting force. On the left y-axis, displacement from 40-130 um is shown. The right y-axis represents force output of the actuator from 0.4N-2 N. The x-axis shows the height of the triangle made by the center most part of the plate-hinge design. Graph 700 further illustrates the relationship between actuator height and both its movement range and maximum output force. The displacement curve indicates how much free stroke the actuator can produce at a given height, typically decreasing as height is reduced due to less material or travel available. The blocking force curve shows the maximum force the actuator can exert without moving, which may increase, decrease, or peak depending on the mechanical design and height-dependent stiffness. By plotting both parameters against the same x-axis, the graph allows for a visual comparison of the relationship between displacement and blocking force as the actuator's form factor changes, helping identify the height that delivers the best balance of movement and force for a specific haptic application.

(A1) In accordance with some embodiments, a wearable electronic device comprises a band structure configured to be worn on a portion of a user's body; a transducer assembly coupled to the band structure, wherein the transducer assembly includes: a piezoelectric substrate configured to displace in a first direction in response to a voltage; and a displacement amplifier coupled to the piezoelectric substrate, the displacement amplifier comprising: a first plate having a first end portion coupled to the piezoelectric substrate; a second plate having a first end portion coupled to the piezoelectric substrate; and a flexible joint coupling a second end portion of the first plate and a second end portion of the second plate, wherein the flexible joint is configured to displace in a second direction different than the first direction in response to displacement of the piezoelectric substrate in the first direction

(A2) In some embodiments of A1, the flexible joint includes a first hinge point in the middle of the flexible joint.

(A3) In some embodiments of any one of A1-A2, the first plate or the second plate of the displacement amplifier has a thickness of less than 5 mil.

(A4) In some embodiments in any one of A1-A3 the flexible joint comprises a first flexible joint plate with a first end of the first flexible joint plate coupled to a second end portion of the first plate and a second flexible joint plate with a second end of the second flexible joint plate coupled to the second end portion of the second plate, and the second end of the first flexible joint plate is coupled to the first end of the second flexible joint plate via a reinforcement element.

(A5) In some embodiments in any one of A1-A4, the reinforcement element is at least one of a steel, tape, or tape with a thickness of less than 2 mil.

(A6) In some embodiments in any one of A1-A5, the flexible joint is configured to displace a first distance greater than 60 μm in the second direction.

(A7) In some embodiments in any one of A1-A6 the transducer assembly is configured to receive an output electrical signal to provide a haptic sensation to the user, provide a capacitance value in response to a static pressure applied to the transducer assembly, and generate an input electrical signal in response to a dynamic load applied to the transducer assembly.

(A8) In some embodiments in any one of A1-A7 the electrical signal is an alternating current (AC) voltage signal.

(A9) In some embodiments in any one of A1-A8, the device further comprising: a processor configured to execute instructions, the instructions configured to: provide the output electrical signal to provide the haptic sensation to the user; receive the capacitance value to measure a static pressure value corresponding to the static pressure applied to the transducer assembly; and receive the input electrical signal to measure a dynamic pressure value corresponding to the dynamic pressure applied to the transducer assembly.

(A10) In some embodiments in any one of A1-A9, the electrical signal is an alternating current (AC) voltage signal.

(A11) In some embodiments in any one of A1-A10 the transducer assembly is configured to operate as a sensor to detect both the one or more static pressure values based on a fit of the band structure on the portion of the user's body and to detect the dynamic pressure value including mechanical waves based on touch-on-world gestures performed by the user.

(A12) In some embodiments in any one of A1-A11 the band structure includes two or more transducer assemblies coupled to an inner portion of the band structure.

(B1) In accordance with some embodiments, a piezo-based module a transducer assembly coupled to a band structure, wherein the transducer assembly includes: a piezoelectric substrate configured to displace in a first direction in response to a voltage; and a displacement amplifier coupled to the piezoelectric substrate, the displacement amplifier comprising: a first plate having a first end portion coupled to the piezoelectric substrate; a second plate having a first end portion coupled to the piezoelectric substrate; and a flexible joint coupling a second end portion of the first plate and a second end portion of the second plate, wherein the flexible joint is configured to displace in a second direction different than the first direction in response to displacement of the piezoelectric substrate in the first direction.

(B2) In some embodiments of B1, the flexible joint includes a first hinge point in the middle of the flexible joint.

(B3) In some embodiments of any one of B1-B2, the flexible joint comprises a first flexible joint plate with a first end of the first flexible joint plate coupled to a second end portion of the first plate and a second flexible joint plate with a second end of the second flexible joint plate coupled to the second end portion of the second plate, and the second end of the first flexible joint plate is coupled to the first end of the second flexible joint plate via a reinforcement element.

(C1) In accordance with some embodiments, a wearable electronic device comprises a band structure configured to be worn on a portion of a user's body; a transducer assembly coupled to the band structure, the transducer assembly comprising: a contact plate configured to contact a user's skin; and a piezo-based transducer coupled to the contact plate, wherein the piezo-based transducer is configured to receive an output electrical signal to provide a haptic sensation to the user through the contact plate, provide a capacitance value in response to a static pressure applied to the contact plate, and generate an input electrical signal in response to a dynamic load applied to the contact plate; and a processor configured to execute instructions, the instructions configured to: provide the output electrical signal to provide the haptic sensation to the user; receive the capacitance value to measure a static pressure value corresponding to the static pressure applied to the contact plate; and receive the input electrical signal to measure a dynamic pressure value corresponding to the dynamic pressure applied to the contact plate.

(C2) In some embodiments of C1, the electrical signal is an alternating current (AC) voltage signal.

(C3) In some embodiments of any one of C1-C2, the transducer assembly is configured to operate as a sensor to detect both the one or more static pressure values based on a fit of the band structure on the portion of the user's body and to detect the dynamic pressure value including mechanical waves based on touch-on-world gestures performed by the user.

(C4) In some embodiments in any one of C1-C3 when a first static pressure measurement of the one or more static pressure measurements detected is determined to be outside of a predetermined threshold, a device in communication with the band structure is configured to indicate to the user that: in accordance with a determination that the first static pressure measurement is too high, the band structure is too tight, and in accordance with a determination that the first static pressure measurement is too low, the band structure is too loose.

(C5) In some embodiments in any one of C1-C4, the portion of the user's body is a wrist of the user.

(C6) In some embodiments in any one of C1-C5, the band structure includes two or more piezo-based modules coupled to an inner portion of the band structure.

(D1) In accordance with some embodiments, a system that includes a wrist wearable device (or a plurality of wrist-wearable devices) and a pair of augmented-reality glasses, and the system is configured to perform operations corresponding to any of A1-C6.

(E1) In accordance with some embodiments, a non-transitory computer readable storage medium including instructions that, when executed by a computing device in communication with a pair of augmented-reality glasses, cause the computer device to perform operations corresponding to any of A1-C6.

(F1) In accordance with some embodiments, a method of operating a pair of augmented-reality glasses, including operations that correspond to any of A1-C6.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

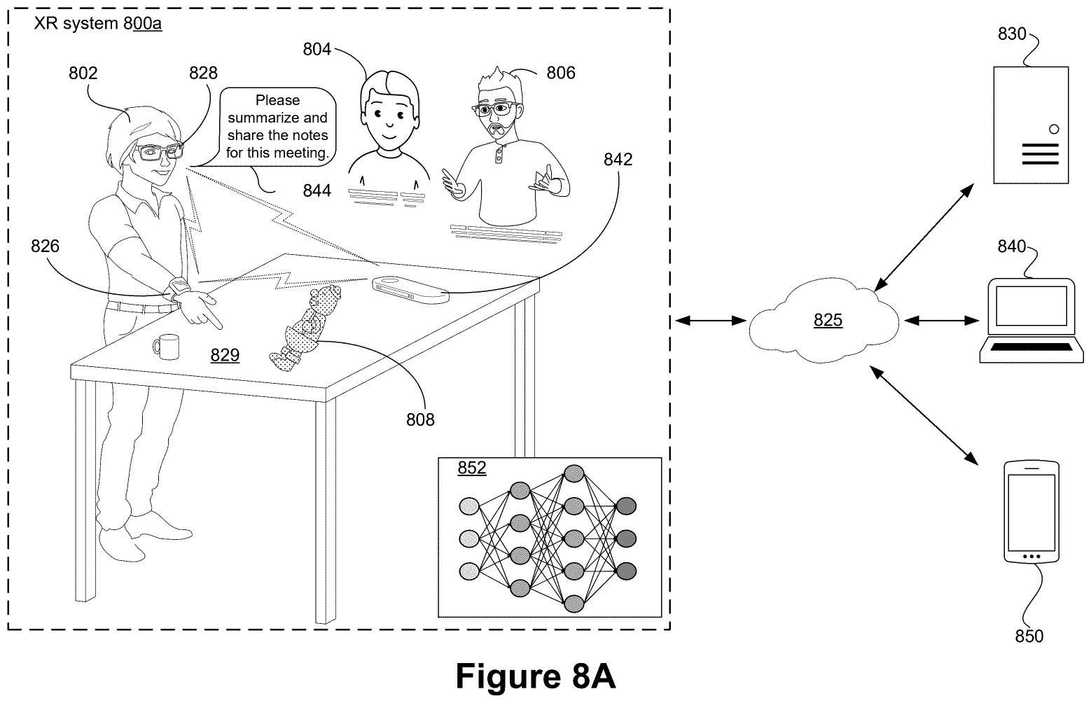

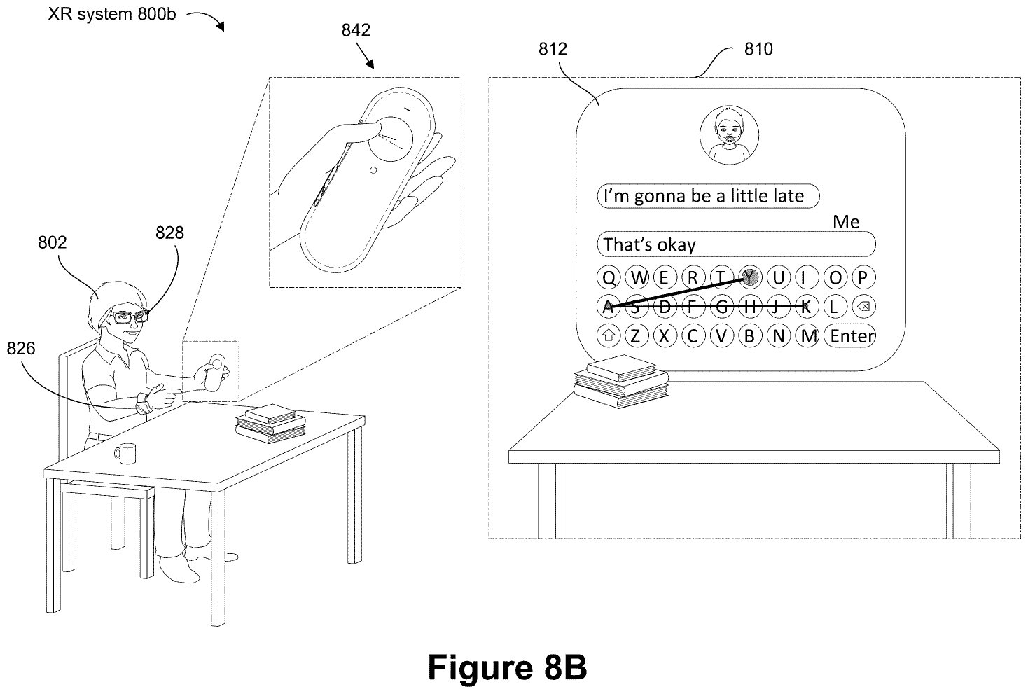

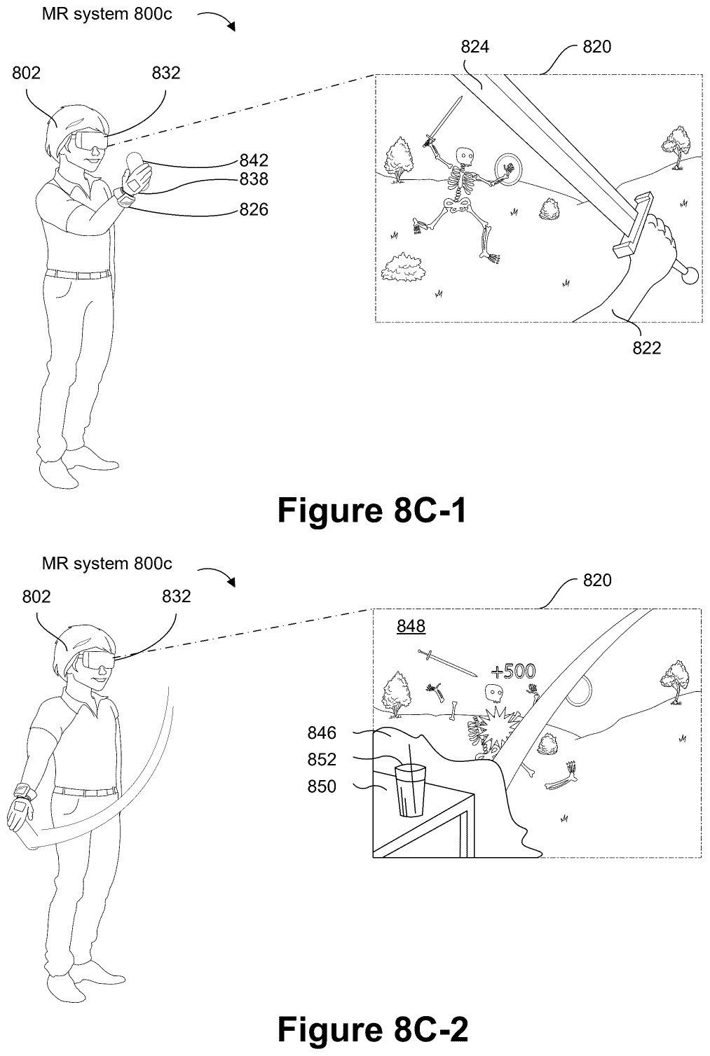

FIGS. 8A, 8B, 8C-1, and 8C-2, illustrate example XR systems that include AR and MR systems, in accordance with some embodiments. FIG. 8A shows a first XR system 800a and first example user interactions using a wrist-wearable device 826, a head-wearable device (e.g., AR device 828), and/or a HIPD 842. FIG. 8B shows a second XR system 800b and second example user interactions using a wrist-wearable device 826, AR device 828, and/or an HIPD 842. FIGS. 8C-1 and 8C-2 show a third MR system 800c and third example user interactions using a wrist-wearable device 826, a head-wearable device (e.g., an MR device such as a VR device), and/or an HIPD 842. As the skilled artisan will appreciate upon reading the descriptions provided herein, the above-example AR and MR systems (described in detail below) can perform various functions and/or operations.

The wrist-wearable device 826, the head-wearable devices, and/or the HIPD 842 can communicatively couple via a network 825 (e.g., cellular, near field, Wi-Fi, personal area network, wireless LAN). Additionally, the wrist-wearable device 826, the head-wearable device, and/or the HIPD 842 can also communicatively couple with one or more servers 830, computers 840 (e.g., laptops, computers), mobile devices 850 (e.g., smartphones, tablets), and/or other electronic devices via the network 825 (e.g., cellular, near field, Wi-Fi, personal area network, wireless LAN). Similarly, a smart textile-based garment, when used, can also communicatively couple with the wrist-wearable device 826, the head-wearable device(s), the HIPD 842, the one or more servers 830, the computers 840, the mobile devices 850, and/or other electronic devices via the network 825 to provide inputs.

Turning to FIG. 8A, a user 802 is shown wearing the wrist-wearable device 826 and the AR device 828 and having the HIPD 842 on their desk. The wrist-wearable device 826, the AR device 828, and the HIPD 842 facilitate user interaction with an AR environment. In particular, as shown by the first AR system 800a, the wrist-wearable device 826, the AR device 828, and/or the HIPD 842 cause presentation of one or more avatars 804, digital representations of contacts 806, and virtual objects 808. As discussed below, the user 802 can interact with the one or more avatars 804, digital representations of the contacts 806, and virtual objects 808 via the wrist-wearable device 826, the AR device 828, and/or the HIPD 842. In addition, the user 802 is also able to directly view physical objects in the environment, such as a physical table 829, through transparent lens(es) and waveguide(s) of the AR device 828. Alternatively, an MR device could be used in place of the AR device 828 and a similar user experience can take place, but the user would not be directly viewing physical objects in the environment, such as table 829, and would instead be presented with a virtual reconstruction of the table 829 produced from one or more sensors of the MR device (e.g., an outward facing camera capable of recording the surrounding environment).

The user 802 can use any of the wrist-wearable device 826, the AR device 828 (e.g., through physical inputs at the AR device and/or built-in motion tracking of a user's extremities), a smart-textile garment, externally mounted extremity tracking device, the HIPD 842 to provide user inputs, etc. For example, the user 802 can perform one or more hand gestures that are detected by the wrist-wearable device 826 (e.g., using one or more EMG sensors and/or IMUs built into the wrist-wearable device) and/or AR device 828 (e.g., using one or more image sensors or cameras) to provide a user input. Alternatively, or additionally, the user 802 can provide a user input via one or more touch surfaces of the wrist-wearable device 826, the AR device 828, and/or the HIPD 842, and/or voice commands captured by a microphone of the wrist-wearable device 826, the AR device 828, and/or the HIPD 842. The wrist-wearable device 826, the AR device 828, and/or the HIPD 842 include an artificially intelligent digital assistant to help the user in providing a user input (e.g., completing a sequence of operations, suggesting different operations or commands, providing reminders, confirming a command). For example, the digital assistant can be invoked through an input occurring at the AR device 828 (e.g., via an input at a temple arm of the AR device 828). In some embodiments, the user 802 can provide a user input via one or more facial gestures and/or facial expressions. For example, cameras of the wrist-wearable device 826, the AR device 828, and/or the HIPD 842 can track the user 802's eyes for navigating a user interface.

The wrist-wearable device 826, the AR device 828, and/or the HIPD 842 can operate alone or in conjunction to allow the user 802 to interact with the AR environment. In some embodiments, the HIPD 842 is configured to operate as a central hub or control center for the wrist-wearable device 826, the AR device 828, and/or another communicatively coupled device. For example, the user 802 can provide an input to interact with the AR environment at any of the wrist-wearable device 826, the AR device 828, and/or the HIPD 842, and the HIPD 842 can identify one or more back-end and front-end tasks to cause the performance of the requested interaction and distribute instructions to cause the performance of the one or more back-end and front-end tasks at the wrist-wearable device 826, the AR device 828, and/or the HIPD 842. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 842 can perform the back-end tasks and provide the wrist-wearable device 826 and/or the AR device 828 operational data corresponding to the performed back-end tasks such that the wrist-wearable device 826 and/or the AR device 828 can perform the front-end tasks. In this way, the HIPD 842, which has more computational resources and greater thermal headroom than the wrist-wearable device 826 and/or the AR device 828, performs computationally intensive tasks and reduces the computer resource utilization and/or power usage of the wrist-wearable device 826 and/or the AR device 828.

In the example shown by the first AR system 800a, the HIPD 842 identifies one or more back-end tasks and front-end tasks associated with a user request to initiate an AR video call with one or more other users (represented by the avatar 804 and the digital representation of the contact 806) and distributes instructions to cause the performance of the one or more back-end tasks and front-end tasks. In particular, the HIPD 842 performs back-end tasks for processing and/or rendering image data (and other data) associated with the AR video call and provides operational data associated with the performed back-end tasks to the AR device 828 such that the AR device 828 performs front-end tasks for presenting the AR video call (e.g., presenting the avatar 804 and the digital representation of the contact 806).

In some embodiments, the HIPD 842 can operate as a focal or anchor point for causing the presentation of information. This allows the user 802 to be generally aware of where information is presented. For example, as shown in the first AR system 800a, the avatar 804 and the digital representation of the contact 806 are presented above the HIPD 842. In particular, the HIPD 842 and the AR device 828 operate in conjunction to determine a location for presenting the avatar 804 and the digital representation of the contact 806. In some embodiments, information can be presented within a predetermined distance from the HIPD 842 (e.g., within five meters). For example, as shown in the first AR system 800a, virtual object 808 is presented on the desk some distance from the HIPD 842. Similar to the above example, the HIPD 842 and the AR device 828 can operate in conjunction to determine a location for presenting the virtual object 808. Alternatively, in some embodiments, presentation of information is not bound by the HIPD 842. More specifically, the avatar 804, the digital representation of the contact 806, and the virtual object 808 do not have to be presented within a predetermined distance of the HIPD 842. While an AR device 828 is described working with an HIPD, an MR headset can be interacted with in the same way as the AR device 828.

User inputs provided at the wrist-wearable device 826, the AR device 828, and/or the HIPD 842 are coordinated such that the user can use any device to initiate, continue, and/or complete an operation. For example, the user 802 can provide a user input to the AR device 828 to cause the AR device 828 to present the virtual object 808 and, while the virtual object 808 is presented by the AR device 828, the user 802 can provide one or more hand gestures via the wrist-wearable device 826 to interact and/or manipulate the virtual object 808. While an AR device 828 is described working with a wrist-wearable device 826, an MR headset can be interacted with in the same way as the AR device 828.

Integration of Artificial Intelligence with XR Systems

FIG. 8A illustrates an interaction in which an artificially intelligent virtual assistant can assist in requests made by a user 802. The AI virtual assistant can be used to complete open-ended requests made through natural language inputs by a user 802. For example, in FIG. 8A the user 802 makes an audible request 844 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 8A also illustrates an example neural network 852 used in Artificial Intelligence applications. Uses of Artificial Intelligence (AI) are varied and encompass many different aspects of the devices and systems described herein. AI capabilities cover a diverse range of applications and deepen interactions between the user 802 and user devices (e.g., the AR device 828, an MR device 832, the HIPD 842, the wrist-wearable device 826). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 802 can interact with an AI model through natural language inputs captured by a voice sensor, text inputs, or any other input modality that accepts natural language and/or a corresponding voice sensor module. In another instance, input is provided by tracking the eye gaze of a user 802 via a gaze tracker module. Additionally, the AI model can also receive inputs beyond those supplied by a user 802. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 828) or from multiple devices that are in communication with each other (e.g., a system that includes at least two of an AR device 828, an MR device 832, the HIPD 842, the wrist-wearable device 826, etc.). The AI model can also access additional information (e.g., one or more servers 830, the computers 840, the mobile devices 850, and/or other electronic devices) via a network 825.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 828, an MR device 832, the HIPD 842, the wrist-wearable device 826) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 828, an MR device 832, the HIPD 842, the wrist-wearable device 826), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 842), haptic feedback can provide information to the user 802. An AI model can also use the inputs described above to determine the appropriate modality and device(s) to present content to the user (e.g., a user walking on a busy road can be presented with an audio output instead of a visual output to avoid distracting the user 802).

### Example Augmented Reality Interaction

FIG. 8B shows the user 802 wearing the wrist-wearable device 826 and the AR device 828 and holding the HIPD 842. In the second AR system 800b, the wrist-wearable device 826, the AR device 828, and/or the HIPD 842 are used to receive and/or provide one or more messages to a contact of the user 802. In particular, the wrist-wearable device 826, the AR device 828, and/or the HIPD 842 detect and coordinate one or more user inputs to initiate a messaging application and prepare a response to a received message via the messaging application.

In some embodiments, the user 802 initiates, via a user input, an application on the wrist-wearable device 826, the AR device 828, and/or the HIPD 842 that causes the application to initiate on at least one device. For example, in the second AR system 800b the user 802 performs a hand gesture associated with a command for initiating a messaging application (represented by messaging user interface 812); the wrist-wearable device 826 detects the hand gesture; and, based on a determination that the user 802 is wearing the AR device 828, causes the AR device 828 to present a messaging user interface 812 of the messaging application. The AR device 828 can present the messaging user interface 812 to the user 802 via its display (e.g., as shown by user 802's field of view 810). In some embodiments, the application is initiated and can be run on the device (e.g., the wrist-wearable device 826, the AR device 828, and/or the HIPD 842) that detects the user input to initiate the application, and the device provides another device operational data to cause the presentation of the messaging application. For example, the wrist-wearable device 826 can detect the user input to initiate a messaging application, initiate and run the messaging application, and provide operational data to the AR device 828 and/or the HIPD 842 to cause presentation of the messaging application. Alternatively, the application can be initiated and run at a device other than the device that detected the user input. For example, the wrist-wearable device 826 can detect the hand gesture associated with initiating the messaging application and cause the HIPD 842 to run the messaging application and coordinate the presentation of the messaging application.

Further, the user 802 can provide a user input provided at the wrist-wearable device 826, the AR device 828, and/or the HIPD 842 to continue and/or complete an operation initiated at another device. For example, after initiating the messaging application via the wrist-wearable device 826 and while the AR device 828 presents the messaging user interface 812, the user 802 can provide an input at the HIPD 842 to prepare a response (e.g., shown by the swipe gesture performed on the HIPD 842). The user 802's gestures performed on the HIPD 842 can be provided and/or displayed on another device. For example, the user 802's swipe gestures performed on the HIPD 842 are displayed on a virtual keyboard of the messaging user interface 812 displayed by the AR device 828.

In some embodiments, the wrist-wearable device 826, the AR device 828, the HIPD 842, and/or other communicatively coupled devices can present one or more notifications to the user 802. The notification can be an indication of a new message, an incoming call, an application update, a status update, etc. The user 802 can select the notification via the wrist-wearable device 826, the AR device 828, or the HIPD 842 and cause presentation of an application or operation associated with the notification on at least one device. For example, the user 802 can receive a notification that a message was received at the wrist-wearable device 826, the AR device 828, the HIPD 842, and/or other communicatively coupled device and provide a user input at the wrist-wearable device 826, the AR device 828, and/or the HIPD 842 to review the notification, and the device detecting the user input can cause an application associated with the notification to be initiated and/or presented at the wrist-wearable device 826, the AR device 828, and/or the HIPD 842.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 828 can present to the user 802 game application data and the HIPD 842 can use a controller to provide inputs to the game. Similarly, the user 802 can use the wrist-wearable device 826 to initiate a camera of the AR device 828, and the user can use the wrist-wearable device 826, the AR device 828, and/or the HIPD 842 to manipulate the image capture (e.g., zoom in or out, apply filters) and capture image data.

While an AR device 828 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 8C-1 and 8C-2, the user 802 is shown wearing the wrist-wearable device 826 and an MR device 832 (e.g., a device capable of providing either an entirely VR experience or an MR experience that displays object(s) from a physical environment at a display of the device) and holding the HIPD 842. In the third AR system 800c, the wrist-wearable device 826, the MR device 832, and/or the HIPD 842 are used to interact within an MR environment, such as a VR game or other MR/VR application. While the MR device 832 presents a representation of a VR game (e.g., first MR game environment 820) to the user 802, the wrist-wearable device 826, the MR device 832, and/or the HIPD 842 detect and coordinate one or more user inputs to allow the user 802 to interact with the VR game.

In some embodiments, the user 802 can provide a user input via the wrist-wearable device 826, the MR device 832, and/or the HIPD 842 that causes an action in a corresponding MR environment. For example, the user 802 in the third MR system 800c (shown in FIG. 8C-1) raises the HIPD 842 to prepare for a swing in the first MR game environment 820. The MR device 832, responsive to the user 802 raising the HIPD 842, causes the MR representation of the user 822 to perform a similar action (e.g., raise a virtual object, such as a virtual sword 824). In some embodiments, each device uses respective sensor data and/or image data to detect the user input and provide an accurate representation of the user 802's motion. For example, image sensors (e.g., SLAM cameras or other cameras) of the HIPD 842 can be used to detect a position of the HIPD 842 relative to the user 802's body such that the virtual object can be positioned appropriately within the first MR game environment 820; sensor data from the wrist-wearable device 826 can be used to detect a velocity at which the user 802 raises the HIPD 842 such that the MR representation of the user 822 and the virtual sword 824 are synchronized with the user 802's movements; and image sensors of the MR device 832 can be used to represent the user 802's body, boundary conditions, or real-world objects within the first MR game environment 820.

In FIG. 8C-2, the user 802 performs a downward swing while holding the HIPD 842. The user 802's downward swing is detected by the wrist-wearable device 826, the MR device 832, and/or the HIPD 842 and a corresponding action is performed in the first MR game environment 820. In some embodiments, the data captured by each device is used to improve the user's experience within the MR environment. For example, sensor data of the wrist-wearable device 826 can be used to determine a speed and/or force at which the downward swing is performed and image sensors of the HIPD 842 and/or the MR device 832 can be used to determine a location of the swing and how it should be represented in the first MR game environment 820, which, in turn, can be used as inputs for the MR environment (e.g., game mechanics, which can use detected speed, force, locations, and/or aspects of the user 802's actions to classify a user's inputs (e.g., user performs a light strike, hard strike, critical strike, glancing strike, miss) or calculate an output (e.g., amount of damage)).

FIG. 8C-2 further illustrates that a portion of the physical environment is reconstructed and displayed at a display of the MR device 832 while the MR game environment 820 is being displayed. In this instance, a reconstruction of the physical environment 846 is displayed in place of a portion of the MR game environment 820 when object(s) in the physical environment are potentially in the path of the user (e.g., a collision with the user and an object in the physical environment are likely). Thus, this example MR game environment 820 includes (i) an immersive VR portion 848 (e.g., an environment that does not have a corollary counterpart in a nearby physical environment) and (ii) a reconstruction of the physical environment 846 (e.g., table 829 and the cup). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 826, the MR device 832, and/or the HIPD 842 are described as detecting user inputs, in some embodiments, user inputs are detected at a single device (with the single device being responsible for distributing signals to the other devices for performing the user input). For example, the HIPD 842 can operate an application for generating the first MR game environment 820 and provide the MR device 832 with corresponding data for causing the presentation of the first MR game environment 820, as well as detect the user 802's movements (while holding the HIPD 842) to cause the performance of corresponding actions within the first MR game environment 820. Additionally or alternatively, in some embodiments, operational data (e.g., sensor data, image data, application data, device data, and/or other data) of one or more devices is provided to a single device (e.g., the HIPD 842) to process the operational data and cause respective devices to perform an action associated with processed operational data.

In some embodiments, the user 802 can wear a wrist-wearable device 826, wear an MR device 832, wear smart textile-based garments 838 (e.g., wearable haptic gloves), and/or hold an HIPD 842 device. In this embodiment, the wrist-wearable device 826, the MR device 832, and/or the smart textile-based garments 838 are used to interact within an MR environment (e.g., any AR or MR system described above in reference to FIGS. 8A-8B). While the MR device 832 presents a representation of an MR game (e.g., second MR game environment 820) to the user 802, the wrist-wearable device 826, the MR device 832, and/or the smart textile-based garments 838 detect and coordinate one or more user inputs to allow the user 802 to interact with the MR environment.

In some embodiments, the user 802 can provide a user input via the wrist-wearable device 826, an HIPD 842, the MR device 832, and/or the smart textile-based garments 838 that causes an action in a corresponding MR environment. In some embodiments, each device uses respective sensor data and/or image data to detect the user input and provide an accurate representation of the user 802's motion. While four different input devices are shown (e.g., a wrist-wearable device 826, an MR device 832, an HIPD 842, and a smart textile-based garment 838) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 838) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 838 can be used in conjunction with an MR device and/or an HIPD 842.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 8A-8C-2 provided above are intended to augment the description provided in reference to FIGS. 1-7. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wearable electronic device, comprising:
a band structure configured to be worn on a portion of a user's body;
a transducer assembly coupled to the band structure, wherein the transducer assembly includes:
a piezoelectric substrate configured to displace in a first direction in response to a voltage; and
a displacement amplifier coupled to the piezoelectric substrate, the displacement amplifier comprising:
a first plate having a first end portion coupled to the piezoelectric substrate;
a second plate having a first end portion coupled to the piezoelectric substrate; and
a flexible joint coupling a second end portion of the first plate and a second end portion of the second plate, wherein the flexible joint is configured to displace in a second direction different than the first direction in response to displacement of the piezoelectric substrate in the first direction.

2. The wearable electronic device of claim 1, wherein the flexible joint includes a first hinge point in the middle of the flexible joint.

3. The wearable electronic device of claim 1, wherein the first plate or the second plate of the displacement amplifier has a thickness of less than 5 mil.

4. The wearable electronic device of claim 1, wherein:
the flexible joint comprises a first flexible joint plate with a first end of the first flexible joint plate coupled to a second end portion of the first plate and a second flexible joint plate with a second end of the second flexible joint plate coupled to the second end portion of the second plate, and
the second end of the first flexible joint plate is coupled to the first end of the second flexible joint plate via a reinforcement element.

5. The wearable electronic device of claim 4, wherein the reinforcement element is at least one of a steel, tape, or tape with a thickness of less than 2 mil.

6. The wearable electronic device of claim 1, wherein the flexible joint is configured to displace a first distance greater than 60 μm in the second direction.

7. The wearable electronic device of claim 1, wherein the transducer assembly is configured to receive an output electrical signal to provide a haptic sensation to the user, provide a capacitance value in response to a static pressure applied to the transducer assembly, and generate an input electrical signal in response to a dynamic load applied to the transducer assembly.

8. The wearable electronic device of claim 7, wherein the electrical signal is an alternating current (AC) voltage signal.

9. The wearable electronic device of claim 7, further comprising:
a processor configured to execute instructions, the instructions configured to:
provide the output electrical signal to provide the haptic sensation to the user;
receive the capacitance value to measure a static pressure value corresponding to the static pressure applied to the transducer assembly; and
receive the input electrical signal to measure a dynamic pressure value corresponding to the dynamic pressure applied to the transducer assembly.

10. The wearable electronic device of claim 9, wherein the transducer assembly is configured to operate as a sensor to detect both the one or more static pressure values based on a fit of the band structure on the portion of the user's body and to detect the dynamic pressure value including mechanical waves based on touch-on-world gestures performed by the user.

11. The wearable electronic device of claim 1, wherein the band structure includes two or more transducer assemblies coupled to an inner portion of the band structure.

12. A piezo-based module comprising:
a transducer assembly coupled to a band structure, wherein the transducer assembly includes:
a piezoelectric substrate configured to displace in a first direction in response to a voltage; and
a displacement amplifier coupled to the piezoelectric substrate, the displacement amplifier comprising:
a first plate having a first end portion coupled to the piezoelectric substrate;
a second plate having a first end portion coupled to the piezoelectric substrate; and
a flexible joint coupling a second end portion of the first plate and a second end portion of the second plate, wherein the flexible joint is configured to displace in a second direction different than the first direction in response to displacement of the piezoelectric substrate in the first direction.

13. The piezo-based module of claim 12, wherein the flexible joint includes a first hinge point in the middle of the flexible joint.

14. The piezo-based module of claim 12, wherein:
the flexible joint comprises a first flexible joint plate with a first end of the first flexible joint plate coupled to a second end portion of the first plate and a second flexible joint plate with a second end of the second flexible joint plate coupled to the second end portion of the second plate, and
the second end of the first flexible joint plate is coupled to the first end of the second flexible joint plate via a reinforcement element.

15. A wearable electronic device, comprising:
a band structure configured to be worn on a portion of a user's body;
a transducer assembly coupled to the band structure, the transducer assembly comprising:
a contact plate configured to contact a user's skin; and
a piezo-based transducer coupled to the contact plate, wherein the piezo-based transducer is configured to receive an output electrical signal to provide a haptic sensation to the user through the contact plate, provide a capacitance value in response to a static pressure applied to the contact plate, and generate an input electrical signal in response to a dynamic load applied to the contact plate; and
a processor configured to execute instructions, the instructions configured to:
provide the output electrical signal to provide the haptic sensation to the user;
receive the capacitance value to measure a static pressure value corresponding to the static pressure applied to the contact plate; and
receive the input electrical signal to measure a dynamic pressure value corresponding to the dynamic pressure applied to the contact plate.

16. The wearable electronic device of claim 15, wherein the electrical signal is an alternating current (AC) voltage signal.

17. The wearable electronic device of claim 15, wherein the transducer assembly is configured to operate as a sensor to detect both the one or more static pressure values based on a fit of the band structure on the portion of the user's body and to detect the dynamic pressure value including mechanical waves based on touch-on-world gestures performed by the user.

18. The wearable electronic device of claim 15, wherein when a first static pressure measurement of the one or more static pressure measurements detected is determined to be outside of a predetermined threshold, a device in communication with the band structure is configured to indicate to the user that:
in accordance with a determination that the first static pressure measurement is too high, the band structure is too tight, and
in accordance with a determination that the first static pressure measurement is too low, the band structure is too loose.

19. The wearable electronic device of claim 15, wherein the portion of the user's body is a wrist of the user.

20. The wearable electronic device of claim 15, wherein the band structure includes two or more piezo-based modules coupled to an inner portion of the band structure.
